(19) United States
(12) Patent Application Publication
(10) Pub. No.: US 2025/0224801 A1
(43) Pub. Date: Jul. 10, 2025

(54) ELECTRONIC DEVICE FOR SUPPORTING AUGMENTED REALITY FUNCTION AND OPERATING METHOD THEREOF

(71) Applicant: SAMSUNG ELECTRONICS CO., LTD., Suwon-si (KR)

(72) Inventors: Hyuntaek WOO, Suwon-si (KR); Sungoh KIM, Suwon-si (KR); Sanghun LEE, Suwon-si (KR); Hyungsok YEO, Suwon-si (KR); Donghyun YEOM, Suwon-si (KR); Dasom LEE, Suwon-si (KR)

(73) Assignee: SAMSUNG ELECTRONICS CO., LTD., Suwon-si (KR)

(21) Appl. No.: 19/092,428

(22) Filed: Mar. 27, 2025

Related U.S. Application Data
(63) Continuation of application No. PCT/KR2023/013339, filed on Sep. 6, 2023.

(30) Foreign Application Priority Data
Sep. 28, 2022 (KR) 10-2022-0123591
Nov. 7, 2022 (KR) 10-2022-0147215

(51) Int. Cl. G06F 3/01; G06T 7/70; G06T 19/00; G06V 40/20

(52) U.S. Cl. CPC G06F 3/011; G06F 3/017; G06T 7/70; G06T 19/006; G06V 40/28

(57) ABSTRACT

There is provided an electronic device and a method for obtaining first data related to a hand of a user from a sensor module; identifying a location of the hand and shapes of joints in the hand by processing the first data using a first artificial intelligence (AI) model; based on the location of the hand identified by using the first AI model, determining whether there is an interaction between the hand and an object included in an augmented reality (AR) image; and based on determining that there is the interaction between the hand of the user and the object included in the AR image, selecting a second AI model; obtaining second data related to the hand from the sensor model; and identifying the location of the hand and the shapes of joints by processing the second data using the second AI model.

### CROSS-REFERENCE TO RELATED APPLICATION

This application is a bypass continuation of International Application No. PCT/KR2023/013339, filed on Sep. 6, 2023, which is based on and claims priority to Korean Patent Application Nos. KR 10-2022-0123591, filed on Sep. 28, 2022, and KR 10-2022-0147215, filed on Nov. 7, 2022, in the Korean Intellectual Property Office, the disclosures of which are incorporated by reference herein in their entireties.

### BACKGROUND

### 1. Field

Various embodiments of the disclosure relate to an electronic device for supporting an augmented reality function and an operation method thereof.

### 2. Description of Related Art

The demand for electronic devices that support an augmented reality (AR) or mixed reality (MR) service, which overlay a virtual images onto an image or onto an background in the real world (real-world elements) to provide information, has been recently increasing.

An example of an electronic device supporting an AR function may be a glasses-type wearable electronic device (or AR glasses). Such a glasses-type wearable electronic device may be worn on a user's body to provide virtual content to the user in the real environment. Glasses-type wearable electronic devices are gaining attention as next-generation immersive media devices according to advancements in communication technologies, such as 5th generation (5G) communication, which enable high-capacity data transmission.

### SUMMARY

An electronic device supporting an AR function may enable a user's eye to recognize an AR image displayed on a display and a real scene which are combined. The real scene may include an external image or and an external real picture in an environment surrounding the user. The user may see the AR image displayed on the display and the real scene simultaneously, and may experience an AR environment in which the AR image is combined with the real scene.

The electronic device supporting the AR function may including an input device that detects, as a user input, an input on a physical button, the user's voice, or the user's hands. The electronic device supporting the AR function may, in order to detect the user's hand, obtain data by using a sensor module and identify the position or the hand or the shape of joints of the hand, based on the obtained data.

The electronic device supporting the AR function may, for an operation of detecting the user' hand, perform multiple calculations including a deep learning calculation using an artificial intelligence model and, accordingly, consume many resources and substantial power.

One or more embodiments of the disclosure may provide an electronic device and a method for, when an operation of detecting a user's hand is performed, adaptively adjusting a calculation amount to reduce unnecessary use of resources so as to increase system efficiency.

One or more embodiments of the disclosure may provide an electronic device and a method for, when an operation of detecting a user's hand is performed, adaptively adjusting a calculation amount to reduce power consumption.

According to an aspect of the disclosure, there is provided an electronic device including: at least one sensor module configured to detect a hand of a user; and a processor operatively connected to the at least one sensor module, wherein the processor is configured to: execute a first application configured to provide an augmented reality (AR) image to the user; select a first artificial intelligence (AI) model, based on execution of the first application; obtain first data related to the hand of the user from the at least one sensor module; identify a position of the hand of the user and a shape of joints in the hand by using the first AI model to calculate the first data; based on the position of the hand of the user and the joints in the hand, identified using the first AI model, determine whether there is an interaction between the hand of the user and at least one object included in the AR image; select a second AI model, based on determination that there is an interaction between the hand of the user and at least one object included in the AR image; obtain second data related to the hand of the user from the at least one sensor module; and identify a position of the hand of the user and a shape of the joints in the hand by using the second AI model to calculate the second data, and wherein the first AI model is configured to process a first calculation amount for a first time period, and the second AI model is configured to process a second calculation amount greater than the first calculation amount for the first time period.

According to another aspect of the disclosure, there is provided a method of an electronic device, the method including: executing a first application configured to provide an augmented reality (AR) image to a user; selecting a first artificial intelligence (AI) model, based on execution of the first application; obtaining first data related to a hand of the user from at least one sensor module; identifying a position of the hand of the user and a shape of joints in the hand by using the first AI model to calculate the first data; based on the position of the hand of the user and the joints in the hand identified using the first AI model, determining whether there is an interaction between the hand of the user and at least one object included in the AR image; selecting a second AI model, based on determination that there is an interaction between the hand of the user and at least one object included in the AR image; obtaining second data related to the hand of the user from the at least one sensor module; and identifying a position of the hand of the user and a shape of the joints in the hand by using the second AI model to calculate the second data, wherein the first AI model is configured to process a first calculation amount for a first time period, and the second AI model configured to process a second calculation amount greater than the first calculation amount for the first time period.

According to an aspect of the disclosure, by using an electronic device and a method according to an embodiment of the disclosure, when an operation of detecting a user's hand is performed, a calculation amount may be adaptively adjusted to reduce unnecessary use of resources so as to increase system efficiency.

According to an aspect of the disclosure, by using an electronic device and a method according to an embodiment of the disclosure, when an operation of detecting a user's hand is performed, a calculation amount may be adaptively adjusted to reduce power consumption.

Effects which are acquirable by the disclosure are not limited to the effects described above, and other effects that have not been mentioned may be clearly understood by a person who has common knowledge in the technical field to which the disclosure belongs, from the following description.

### BRIEF DESCRIPTION OF DRAWINGS

Other aspects, features, and advantages according to specific embodiments of the disclosure will become more apparent from the relevant accompanying drawings and descriptions.

FIG. 1 is a block diagram of an electronic device in a network environment according to an embodiment;

FIG. 2 is a diagram illustrating an electronic device according to embodiments of the disclosure;

FIG. 3 is a block diagram of a configuration of an electronic device according to an embodiment;

FIG. 4A illustrates an example of image data obtained through a depth sensor of an electronic device according to an embodiment;

FIG. 4B illustrates an example of image data obtained through an infrared sensor of an electronic device according to an embodiment;

FIG. 4C illustrates an example of image data obtained through a camera module of an electronic device according to an embodiment;

FIG. 5A illustrates a diagram illustrating an example of a method of calculating a position of a hand by an electronic device according to an embodiment;

FIG. 5B is a diagram illustrating an example of a method of calculating a center point of a hand by an electronic device according to an embodiment;

FIG. 6 is a diagram illustrating an example of a method of identifying a shape of hand joints by an electronic device according to an embodiment;

FIG. 7 is a flowchart illustrating an operation of an electronic device according to an embodiment;

FIG. 8 is a flowchart illustrating an operation according to a variable mode of an electronic device according to an embodiment;

FIG. 9 is a flowchart illustrating an operation of determining whether there is an interaction by an electronic device according to an embodiment;

FIG. 10A illustrates a pointing gesture as an example of a designated gesture according to an embodiment;

FIG. 10B illustrates a pinch gesture as an example of a designated gesture according to an embodiment;

FIG. 11 illustrates an example of a user scenario of determining that there is no interaction by an electronic device according to an embodiment;

FIG. 12 illustrates an example of a user scenario of determining that there is an interaction by an electronic device according to an embodiment;

FIG. 13 is an example illustrating a state where an electronic device according to an embodiment executes a second fixed mode, based on determining that there is an interaction;

FIG. 14 is an example illustrating a state where an electronic device according to an embodiment has executed a first fixed mode; and

FIG. 15 is an example illustrating a state where an electronic device according to an embodiment executes a second fixed mode.

It should be noted that the same reference numerals are used throughout the drawings to depict identical or similar elements, features, and structures.

### DETAILED DESCRIPTION

The following description, referring to the attached drawings, is provided to assist in a comprehensive understanding of various embodiments of the disclosed content as defined by the claims and their equivalents. It includes various specific details intended to aid in understanding, but these should be considered merely illustrative. Thus, a person skilled in the art will recognize that various modifications and changes to various embodiments described herein may be made without departing from the scope and spirit of the disclosure. Furthermore, descriptions of well-known functions and configurations may be omitted for clarity and conciseness.

The terms and words used in the following description and claims are not limited to their literal meanings in the literature but are used as employed by the applicant to facilitate a clear and consistent understanding of this document. Therefore, it should be apparent to those skilled in the art that the following description of various embodiments of this document is provided solely for illustrative purposes and is not intended to limit this document as defined by the attached claims and their equivalents.

Unless explicitly indicated otherwise by context, the singular form should be understood to include the plural. Therefore, for example, a reference to a “element surface” may include one or more such surfaces.

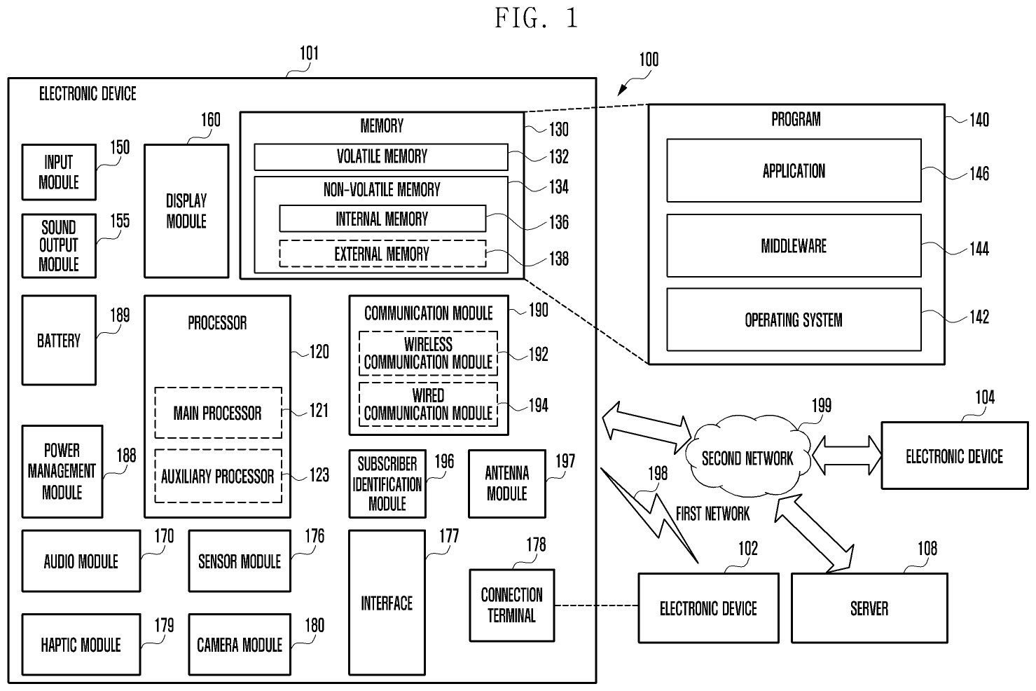

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC provided on a first surface (e.g., the bottom surface) of the printed circuit board, or adjacent to the first surface and capable of supporting a designated high-frequency band (e.g., the mmWave band), and a plurality of antennas (e.g., array antennas) provided on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately provided in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In various embodiments of the disclosure, “augmented reality” may refer to displaying an image by overlaying a virtual image generated by a computer onto a physical environmental space of the real world (a physical, real-world environment) or a real object (real-world object).

In various embodiments of the disclosure, an “augmented reality display device” is a device capable of representing augmented reality, and may include a head mounted display apparatus or an augmented reality helmet as well as a glasses-type augmented reality glasses device (augmented reality glasses) worn by a user. Such augmented reality display devices are being usefully applied in everyday life for tasks such as information retrieval, navigation, and camera capture. In addition, an augmented reality glasses device, which is a glasses-type form of an augmented reality display device, is worn as a fashion item and may be used in both indoor and outdoor activities.

In various embodiments of the disclosure, a “real scene” (e.g., external image or external real picture) refers to a scene in the real world viewed by an observer or user through an electronic device (e.g., AR glasses, or an augmented reality display device), and may include a real object (real-world object).

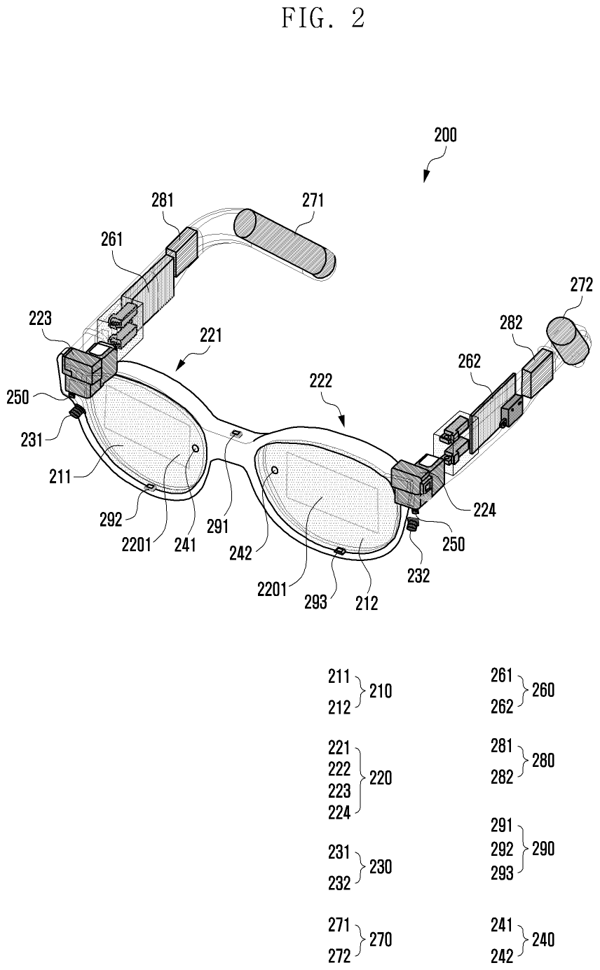

In various embodiments of the disclosure, an “AR image” or “a virtual image” may be an image generated through a display unit (e.g., a display unit 220 in FIG. 2) (e.g., a display engine). The AR image (or virtual image) may include both static and dynamic images. Such an AR image (or virtual image) may be an image which is overlaid onto a real scene (e.g., external image or external real picture) to display information on a real object in the real scene (e.g., external image or external real picture), information on an operation of an augmented reality device, or a control menu.

In various embodiments of the disclosure, the phrase “the electronic device 101 provides an AR image” may imply that “the electronic device (101) displays an AR image to allow a user to experience an AR environment”. Thus, in various embodiments of the disclosure, the term “AR image” may be interpreted as having the same or similar meaning to “AR environment”. However, the disclosure is not limited thereto.

FIG. 2 is a diagram illustrating an electronic device according to embodiments of the disclosure.

Referring to FIG. 2, an electronic device 200 according to an embodiment of the disclosure may include augmented reality (AR) glass. For example, the electronic device 200 may include a head mounted device (HMD).

According to an embodiment, the electronic device 200 may include a glass unit 210, a display unit 220, a tracking camera unit 230, an eye tracking (ET) camera unit 240, an LED illumination 250, a printed circuit board (PCB) unit 260, a battery unit 270, a speaker unit 280, and a microphone unit 290. However, the disclosure is not limited thereto, and as such, the electronic device 200 may include one or more additional hardware components, or omit one or more components. For example, the electronic device 200 may include an IMU sensor.

According to an embodiment, the glass unit 210 may include a first glass member 211 (e.g., a glass member for the right eye) and a second glass member 212 (e.g., a glass member for the left eye). For example, the glass unit 210 may be positioned on a front surface of the display unit 220 to protect the display unit 220. For example, the first glass member 211 and/or the second glass member 212 may be made of a glass plate or polymer, and may be manufactured to be transparent or semi-transparent. According to an embodiment, the first glass member 211 and the second glass member 212 may be connected and integrated. For example, the glass unit 210 may adjust the transmission of external light incident to the display unit 220.

According to an embodiment, the display unit 220 may include a first display unit 221 provided to correspond to the right eye and a second display unit 222 provided to correspond to the left eye.

According to an embodiment, the elements of the first display unit 221 may be same as those of the second display unit 222. For example, the arrangement of components configuring the first display unit 221 and/or the shapes of the components may be same as the arrangement of components configuring the second display unit 221 and/or the shapes of the components.

According to an embodiment, each of the first display unit 221 and the second display unit 222 may include a display configured to output an image, a projection lens, an optical combiner (combiner optics) 2201, and an optical barrier (e.g., barrel). However, the disclosure is not limited thereto, and as such, each of the first display unit 221 and the second display unit 222 may include one or more additional hardware components, or omit one or more components.

According to an embodiment, the display included in each of the first display unit 221 and the second display unit 222 may include a silicon liquid crystal display device (liquid crystal on silicon, LCoS), a light-emitting diode (LED) on silicon (LEDoS), an organic light emitting diode (OLED), a micro light-emitting diode (micro LED), or a digital mirror display device (digital mirror device, DMD).

According to an embodiment, the tracking camera unit 230 may include a first tracking camera 231 and a second tracking camera 232. For example, the tracking camera unit 230 may be a camera used for head tracking, hand detection, hand tracking, and/or space recognition of 3 degrees of freedom (3DoF) or 6DoF. The tracking camera unit 230 may include a global shutter (GS) camera. The tracking camera unit 230 may include a stereo camera for head tracking and space recognition, and for example, may be configured by two cameras (e.g., the first tracking camera 231 and the second tracking camera 232).

According to an embodiment, the eye tracking camera unit 240 may include a first eye tracking (ET) camera 241 (e.g., a right-eye tracking camera) and a second ET camera 242 (e.g., a left-eye tracking camera). For example, the eye tracking camera unit 240 may detect a pupil of the user and track the motion of the pupil. For example, the eye tracking camera unit 240 may detect the user's pupils (e.g., right eye and left eye) and track the motion of the pupils. The electronic device 202 may track the motion of the pupils by using the eye tracking camera unit 240 so that the center of an AR image displayed on the electronic device 200 (e.g., AR glasses) is adjusted according to a direction in which a user is looking.

According to an embodiment, the LED illumination 250 may be attached to a frame of the electronic device 200 (e.g., AR glasses). In an example case in which an image of a user's pupils is captured by the eye tracking camera unit 240, the LED illumination 250 may emit an infrared wavelength so as to smoothly detect the pupils. According to an embodiment, the LED illumination 250 may be used as a means for supplementing ambient light when an image of the surrounding is captured by the tracking camera unit 230.

According to an embodiment, the display unit 220 may include a first display driving unit 223 for driving the first display unit 221 and a second display driving unit 224 for driving the second display unit 222.

According to an embodiment, the PCB unit 260 may be provided in leg parts of the electronic device 200 (e.g., AR glasses), and may include a first PCB 261 and a second PCB 262. For example, the PCB unit 260 may include a memory (e.g., the memory 130 in FIG. 1) and at least one driving unit (e.g., the processor 120 in FIG. 1) for controlling the glass unit 210, the tracking camera unit 230, the eye tracking camera unit 240, the LED illumination 250, the speaker unit 280, and the microphone unit 290.

According to an embodiment, the battery unit 270 (e.g., the battery 189 in FIG. 1) may be provided in the leg parts of the electronic device (e.g., AR glasses), and may include a first battery 271 and a second battery 272. The power for driving the glass unit 210, the display unit 220, the tracking camera unit 230, the eye tracking camera unit 240, the LED illumination 250, the PCB unit 260, the speaker unit 280, and the microphone unit 290 may be supplied through the battery unit 270.

According to an embodiment, the speaker unit 280 (e.g., the audio module 170 in FIG. 1) may include a first speaker 281 (e.g., a right speaker) and a second speaker 282 (e.g., a left speaker). For example, the speaker unit 280 may output sound according to control of the driving unit of the PCB unit 260.

According to an embodiment, the microphone unit 290 (e.g., the audio module 170 in FIG. 1) may include a first microphone 291 (e.g., a top microphone), a second microphone 292 (e.g., a right microphone), and a third microphone 293 (e.g., a left microphone). For example, a user's voice and external sound may be converted into an electrical signal through the microphone unit 290. For example, the first microphone 291 (e.g., a top microphone), the second microphone 292 (e.g., a right microphone), and the third microphone 293 (e.g., a left microphone) may include a microphone of a condenser, dynamic (moving coil and ribbon), piezoelectric, or micro-electro mechanical systems (MEMS) type.

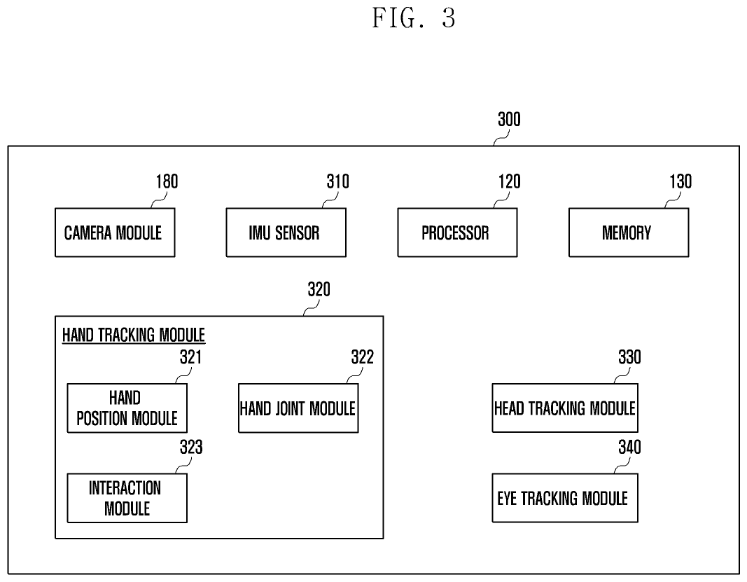

FIG. 3 is a block diagram of a configuration of an electronic device 300 according to an embodiment. According to an embodiment, the electronic device 300 may include the electronic device 101 in FIG. 1 or the electronic device 200 in FIG. 2. However, the disclosure is not limited thereto, and as such, the electronic device 300 may be another electronic device

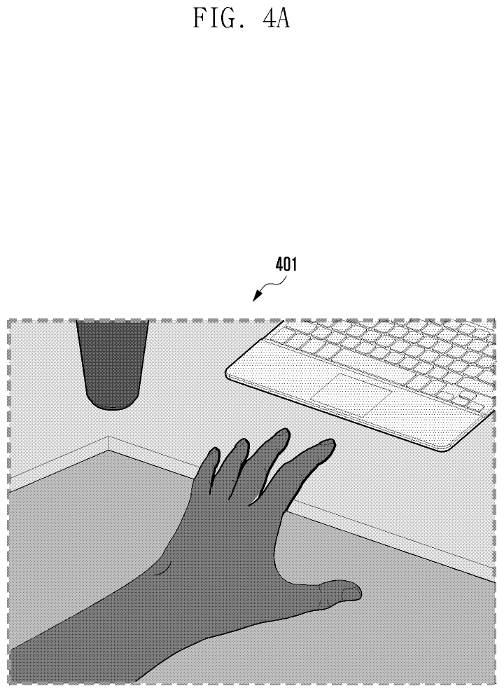

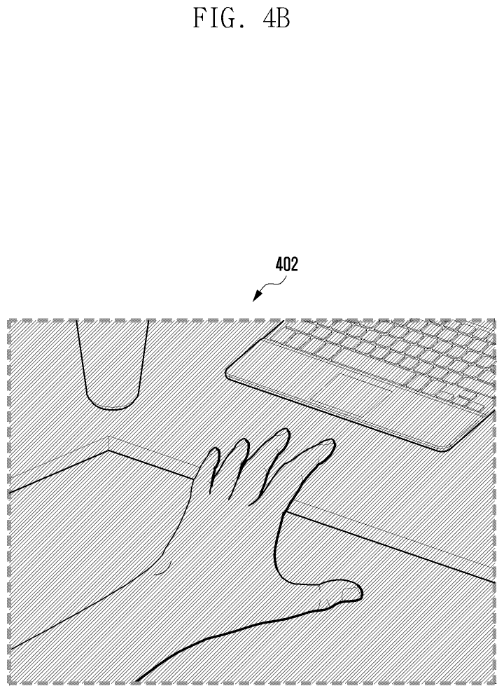

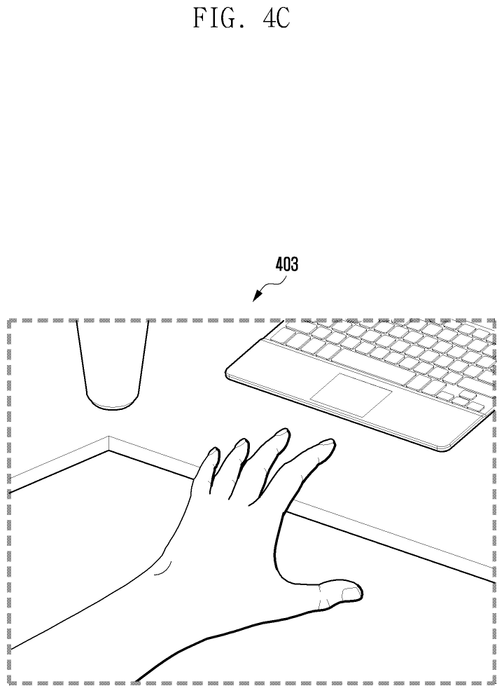

FIG. 4A illustrates an example of image data obtained through a depth sensor of the electronic device 300 according to an embodiment.

FIG. 4B illustrates an example of image data obtained through an infrared sensor of the electronic device 300 according to an embodiment.

FIG. 4C illustrates an example of image data obtained through the camera module 180 of the electronic device 300 according to an embodiment.

Referring to FIG. 3, the electronic device 300 according to an embodiment may include a vision processing module that obtains data from a camera module 180 (e.g., the camera module 180 in FIG. 1) and/or c310 (e.g., the sensor module 176 in FIG. 1), and calculates information related to a user's hands, eyes, the position of the hands, or the position of the eyes, based on the obtained data. For example, the electronic device 300 may include, as the vision processing module, the camera module 180, the IMU sensor 310, a processor 120 (e.g., the processor 120 in FIG. 1), a memory 130 (e.g., the memory 130 in FIG. 1), a hand tracking module 320, a head tracking module 330, or an eye tracking module 340. The hand tracking module 320 may include a hand position module 321, a hand joint module 322, or an interaction module 323.

According to an embodiment, the inertial motion unit (IMU) sensor 310 may detect and track the change (e.g., a degree of motion) of the electronic device 300. The IMU sensor 310 may convert a detected motion change signal into a digital signal (e.g., a sensor value or a sensor waveform), and transfer the digital signal to the processor 120. The IMU sensor 310 may generate a sensor waveform capable of representing the path of motion in a pre-configured unit. The sensor waveform may be time-serial sensor data for feature extraction.

According to an embodiment, the IMU sensor 310 may be implemented as a module configured by a 3-axis accelerometer, a gyroscope, and a magnetometer sensor. According to an embodiment, the IMU sensor 310 may be a motion sensor including at least one of an acceleration sensor, a tilt sensor, a gyro sensor, or a magnetic sensor (3-axis magnetic sensor). The IMU sensor 310 may extract angle information, such as a pitch, a roll, or a yaw, by using a gyro sensor, track (jump, movement speed) a speed direction by using an acceleration sensor, and track a magnetic field value of Earth by using a geomagnetic sensor so as to track a motion direction.

According to an embodiment, the hand tracking module 320, the head tracking module 330, or the eye tracking module 340 may be named “a sub-task processing module”. The vision processing module may receive data (e.g., sensing data) from the camera module 180 or the IMU sensor 310, and transfer the received data to each sub-task module (e.g., the hand tracking module 320, the head tracking module 330, or the eye tracking module 340) included in a sub-task processing module. Each sub-task module may calculate information related to the user's hands, eyes, the position of the hands, or the position of the eyes, based on the received data, and provide a result of the calculation to the user. For example, each sub-task module may provide information corresponding to a result of the calculation in a form of a screen or sound.

According to an embodiment, the camera module 180 may be configured to obtain image data corresponding to a real scene (e.g., external image or external real picture) by capturing an image of a real object (real world object) positioned around the electronic device 300 (positioned in front of the electronic device 300).

According to an embodiment, the processor 120 may be configured to control overall operations of the electronic device 300. The processor 120 may include at least one sub-task module so that the electronic device 300 generates an AR image and the user interacts with at least one object included in the AR image. For example, the processor 120 may include the hand tracking module 320, the head tracking module 330, or the eye tracking module 340. The processor 120 may include a neural processing unit (NPU) optimized for deep learning calculation for hand tracking.

According to an embodiment, the memory 130 may store instructions causing the electronic device 300 to perform operations. The memory 130 may store instructions that, when executed by the processor 120, causing the electronic device 300 to perform operations described in various embodiments of the disclosure. The memory 130 may be a device that stores multiple applications and stores multiple configuration values and various data.

According to an embodiment, the hand tracking module 320 is a sub-task module in the vision processing module, and may be a module that calculates the user's hand position, based on image data input from the camera module 180 or sensing data input from the IMU sensor 310. According to an embodiment, the hand tracking module 320 may be included in the processor 120.

Referring to FIG. 3 and FIG. 4A, the hand tracking module 320 according to an embodiment may obtain image data 401 (e.g., first image data) including depth information by using a depth sensor and perform hand recognition by using the image data 401 including the depth information.

Referring to FIG. 3 and FIG. 4B, the hand tracking module 320 according to an embodiment may obtain image data 402 (e.g., second image data) including infrared information by using an infrared sensor and perform hand recognition by using the image data 402 including the infrared information.

Referring to FIG. 3 and FIG. 4C, the hand tracking module 320 according to an embodiment may obtain image data 403 (e.g., third image data) including red, green, blue (RGB) information by using the camera module 180 and perform hand recognition by using the image data 403 including the RGB information.

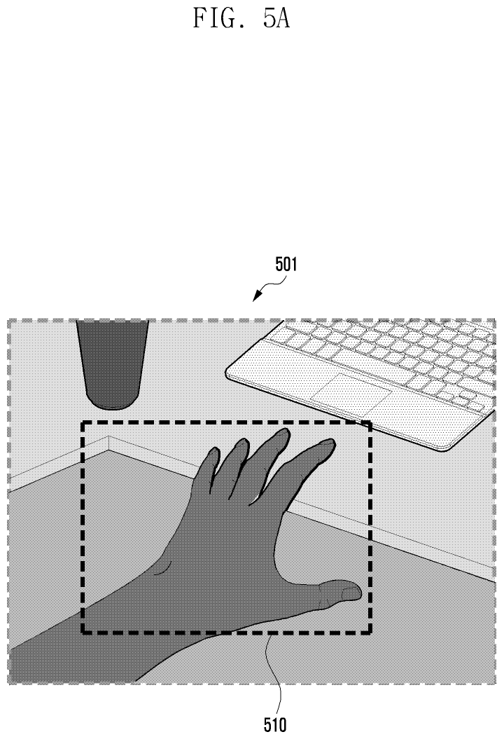

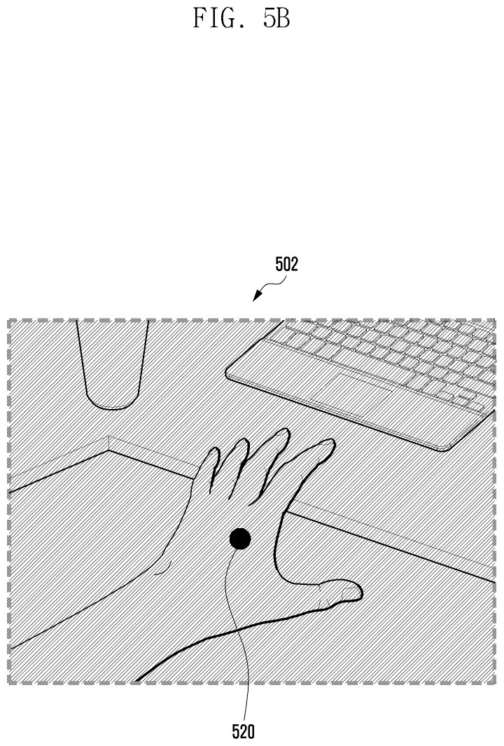

FIG. 5A illustrates a diagram illustrating an example of a method of calculating a position of a hand by the electronic device 300 according to an embodiment.

FIG. 5B is a diagram illustrating an example of a method of calculating a center point of a hand by the electronic device 300 according to an embodiment.

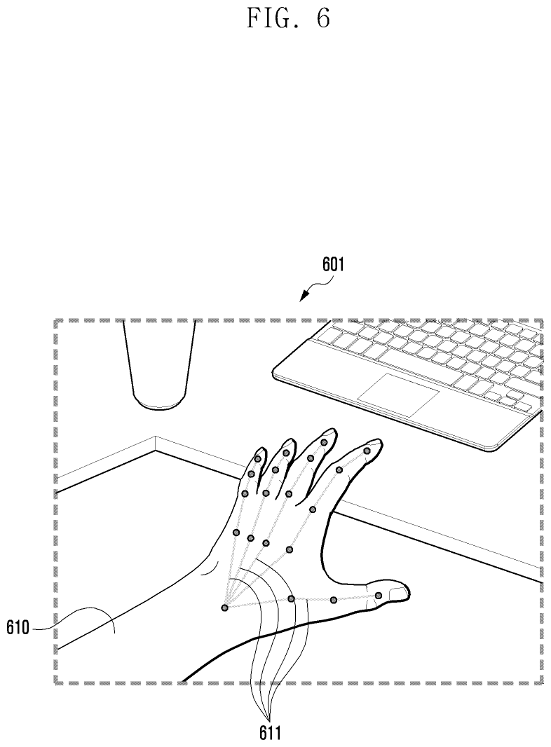

FIG. 6 is a diagram illustrating an example of a method of identifying a shape of hand joints by the electronic device 300 according to an embodiment.

Referring to FIG. 3, FIG. 5A, and FIG. 5B, the hand tracking module 320 according to an embodiment may include the hand position module 321. The hand position module 321 may be configured to obtain information about the position of the user's hand. For example, the hand position module 321 may be configured to, based on input image data or input sensing data, calculate whether the user's hand is currently positioned in a specific direction of the electronic device 300, or calculate the position of the user's hand. For example, the specific direction may be a designated direction, which may include, but is not limited to, the hand being positioned in front of the electronic device 300. For example, as illustrated in FIG. 5A, the hand position module 321 may determine a box area 510 representing the position of the user's hand, based on input image data 501 or input sensing data. For example, as illustrated in FIG. 5B, the hand position module 321 may determine a point 520 representing a center point of the user's hand, based on input image data 502 or input sensing data.

According to an embodiment, the hand position module 321 may, in calculating whether the user's hand is present or calculating the position of the user's hand, perform a first deep learning calculation using a first artificial intelligence (AI) model or perform a second deep learning calculation using a second AI model.

Referring to FIG. 3 and FIG. 6, the hand tracking module 320 according to an embodiment may include the hand joint module 322. The hand joint module 322 may be configured to identify (e.g., calculate) the joint shape of the user's hand, based on input image data or input sensing data. For example, as illustrated in FIG. 6, the hand joint module 322 may estimate a joint image 611 in which the joint knuckles of a hand of a user 610 are connected, based on input image data 601 or input sensing data. The hand joint module 322 may determine the shape of the joints according to the shape of the estimated joint image 611. According to an embodiment, the electronic device 300 may identify the joint shape of the user's hand by using the hand joint module 322, to identify a gesture of the user's hand. According to an embodiment, the hand joint module 322 may, in identifying the joint shape of the user's hand, perform a first deep learning calculation using a first AI model or perform a second deep learning calculation using a second AI model.

According to an embodiment, the first AI model may be an AI model which is highly efficient and has a smaller calculation amount, which is processed for a particular time period, compared to the second AI model. For example, the first AI model may have a relatively smaller resource usage of the processor 120, compared to the second AI model. The first AI model may be an AI model configured to process image data of a first frame per second (FPS). The power consumption of the electronic device 300 according to a deep learning calculation using the first AI model may be smaller than that of the electronic device 300 according to a deep learning calculation using the second AI model. In various embodiments of the disclosure, the first AI model may be named a high-efficiency AI model.

According to an embodiment, the second AI model may be an AI model which exhibits high performance and has a greater calculation amount, which is processed for a particular time or period, compared to the first AI model. For example, the second AI model may have a relatively greater resource usage of the processor 120, compared to the first AI model. The second AI model may be an AI model configured to process image data of a second FPS. For example, the second FPS is greater than the first FPS). The power consumption of the electronic device 300 according to a deep learning calculation using the second AI model may be greater than that of the electronic device 300 according to a deep learning calculation using the first AI model. In various embodiments of the disclosure, the second AI model may be named a high-performance AI model.

According to an embodiment, the hand position module 321 and the hand joint module 322 may be configured to, in an example case in which the electronic device 300 satisfies a first condition, fixedly perform a first deep learning calculation using the first AI model, and this state may be defined as a “first fixed mode (e.g., first mode”). The first condition may include receiving the user's direct input, or detecting a state where the remaining battery power (e.g., battery level) of the electronic device 300 is lower than a threshold value.

According to an embodiment, the hand position module 321 and the hand joint module 322 may be configured to, in an example case in which the electronic device 300 satisfies a second condition, fixedly perform a second deep learning calculation using the second AI model, and this state may be defined as a “second fixed mode (e.g., second mode”). The second condition may include receiving the user's direct input, or the user's gesture repeatedly failing to be recognized. The user's gesture repeatedly failing to be recognized may imply, for example, a state where the number of times that a command (e.g., a command related to at least one object included in an AR image) corresponding to a user gesture fails to be recognized exceeds a designated threshold value.

According to an embodiment, the hand position module 321 and the hand joint module 322 may be configured to, in an example case in which the electronic device 300 does not satisfy the first condition and the second condition, use one of the first AI model or the second AI model according to whether the user interacts with at least one object included in an AR image, and this state may be defined as a “variable mode (e.g., third mode or fourth mode)”. According to an embodiment, the hand position module 321 and the hand joint module 322 may execute the variable mode, based on receiving the user's direct input. The variable mode may include a first variable mode (e.g., third mode) of performing hand tracking by using the first AI model or a second variable mode (e.g., fourth mode) of performing hand tracking by using the second AI model.

The hand tracking module 320 may include the interaction module 323. The interaction module 323 may be configured to receive data related to the shape of the hand from the hand joint module 322, and cause the shape of the hand to be stored in the memory 130 or calculate whether an interaction with at least one object included in an AR image is possible or whether there is an interaction. For example, the interaction module 323 may, in calculating whether an interaction is possible or whether there is an interaction, comprehensively consider at least some of the position of the hand, the position of each hand joint, the current state of the object, or the current position of the object. Whether there is an interaction, which is determined by the interaction module 323, may correspond to a condition for allowing the electronic device 300 to select one of the first AI model or the second AI model while being in the variable mode. In an example case in which an interaction is absent, the electronic device 300 may, in the variable mode, perform hand tracking (calculating the hand position or identifying the shape of hand joints) using the first AI model. In an example case in which an interaction is present, the electronic device 300 may, in the variable mode, perform hand tracking using the second AI model.

According to an embodiment, the head tracking module 330 may perform head tracking, based on data input from the camera module 180. For example, the head tracking module 330 may be configured to obtain data from the tracking camera unit 230, as described with reference to FIG. 2, and detect the motion of the user's head, based on the obtained data. According to an embodiment, the head tracking module 330 may be included in the processor 120.

According to an embodiment, the eye tracking module 340 may track the motion of the user's pupils, based on data input from the camera module 180. For example, the eye tracking module 340 may be configured to obtain data from the eye tracking camera unit 240, as described with reference to FIG. 2, and determine a direction corresponding to the user's gaze, based on the obtained data. According to an embodiment, the eye tracking module 340 may be included in the processor 120.

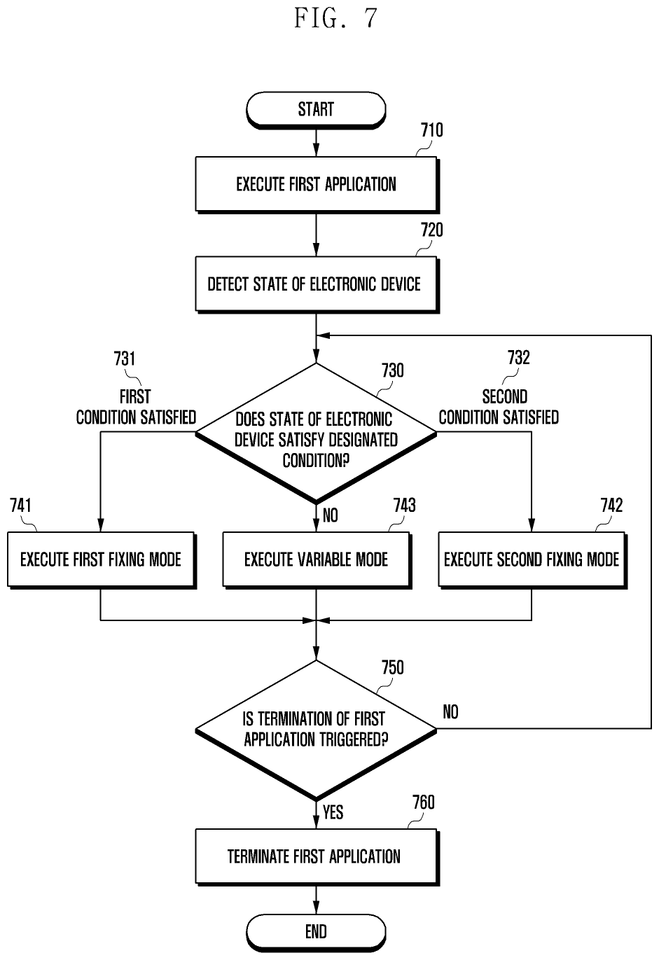

FIG. 7 is a flowchart illustrating an operation of the electronic device 300 according to an embodiment.

At least some of the operations illustrated in FIG. 7 may be omitted. At least some operations mentioned with reference to other drawings in various embodiments of the disclosure may be added and inserted before or after at least some operations illustrated in FIG. 7.

Operations illustrated in FIG. 7 may be performed by the processor 120 (e.g., the processor 120 in FIG. 1). For example, the memory 130 (e.g., the memory 130 in FIG. 1) of the electronic device 300 (e.g., the electronic device 300 in FIG. 3) may store instructions that, when executed, cause the processor 120 to perform at least some operations illustrated in FIG. 7. Hereinafter, an operation of the electronic device 300 according to an embodiment is described with reference to FIG. 7.

In operation 710, the electronic device 300 according to an embodiment may execute a first application related to an AR function. The first application may be an application providing an image which is overlaid onto a real scene (e.g., external image or external real picture) to display information on a real object in the real scene, information on an operation of the augmented reality device, or a control menu.

According to an embodiment, while the first application is being executed, the electronic device 300 may repeat a hand tracking operation (e.g., operation 720 to operation 750) using the hand tracking module 320, and when the execution of the first application is terminated, the electronic device 300 may stop the hand tracking operation (e.g., operation 720 to operation 750) using the hand tracking module 320.

In operation 720 and operation 730, the electronic device 300 according to an embodiment may detect a state of the electronic device 300, based on the first application being executed. For example, the electronic device 300 may determine whether a first condition or a second condition is satisfied. The first condition may include receiving the user's direct input, or detecting a state where the remaining battery power of the electronic device 300 is lower than a threshold value. The second condition may include receiving the user's direct input, or the user's gesture repeatedly failing to be recognized. The user's gesture repeatedly failing to be recognized may imply, for example, a state where the number of times that a command (e.g., a command related to at least one object included in an AR image) corresponding to a user gesture fails to be recognized exceeds a designated threshold value.

In operation 730, the electronic device 300 according to an embodiment may perform operation 741 in an example case in which the first condition is satisfied (e.g., the result of operation 730 is as indicated by reference numeral 731).

In operation 730, the electronic device 300 according to an embodiment may perform operation 742 in an example case in which the second condition is satisfied (e.g., the result of operation 730 is as indicated by reference numeral 732).

In operation 730, the electronic device 300 according to an embodiment may perform operation 743 in an example case in which the first condition and the second condition are not satisfied (e.g., the result of operation 730 is “No”).

In operation 741, the electronic device 300 according to an embodiment may execute a first fixed mode. According to an embodiment, the hand position module 321 and the hand joint module 322 may perform hand tracking based on the first fixed mode in an example case in which the electronic device 300 satisfies the first condition. For example, the hand position module 321 and the hand joint module 322 may be configured to, in the first fixed mode, fixedly perform a first deep learning calculation using a first AI model.

According to an embodiment, the first AI model may be an AI model which is highly efficient and has a smaller calculation amount, which is processed for a particular time period, compared to the second AI model. For example, the first AI model may have a relatively smaller resource usage of the processor 120, compared to the second AI model. The first AI model may be an AI model configured to process image data of a first frame per second (FPS). The power consumption of the electronic device 300 according to a deep learning calculation using the first AI model may be smaller than that of the electronic device 300 according to a deep learning calculation using the second AI model. In various embodiments of the disclosure, the first AI model may be named a high-efficiency AI model.

In operation 742, the electronic device 300 according to an embodiment may execute a second fixed mode. According to an embodiment, the hand position module 321 and the hand joint module 322 may perform hand tracking based on the second fixed mode in an example case in which the electronic device 300 satisfies the second condition. For example, the hand position module 321 and the hand joint module 322 may be configured to, in the second fixed mode, fixedly perform a second deep learning calculation using a second AI model.

According to an embodiment, the second AI model may be an AI model which exhibits high performance and has a greater calculation amount, which is processed for a particular time period, compared to the first AI model. For example, the second AI model may have a relatively greater resource usage of the processor 120, compared to the first AI model. The second AI model may be an AI model configured to process image data of a second FPS (e.g., the second FPS is greater than the first FPS). The power consumption of the electronic device 300 according to a deep learning calculation using the second AI model may be greater than that of the electronic device 300 according to a deep learning calculation using the first AI model. In various embodiments of the disclosure, the second AI model may be named a high-performance AI model.

In operation 743, the electronic device 300 according to an embodiment may execute a variable mode. According to an embodiment, the hand position module 321 and the hand joint module 322 may be configured to, in the variable mode, use one of the first AI model or the second AI model according to whether the user interacts with at least one object included in an AR image. According to an embodiment, the hand position module 321 and the hand joint module 322 may execute the variable mode, based on receiving the user's direct input. The electronic device 300 according to an embodiment may, in the variable mode, use the high-performance second AI model for the hand that is interacting so as to increase the accuracy of calculation results and use the high-efficiency first AI model for the area in which there is no interaction so as to increase the efficiency of resource management.

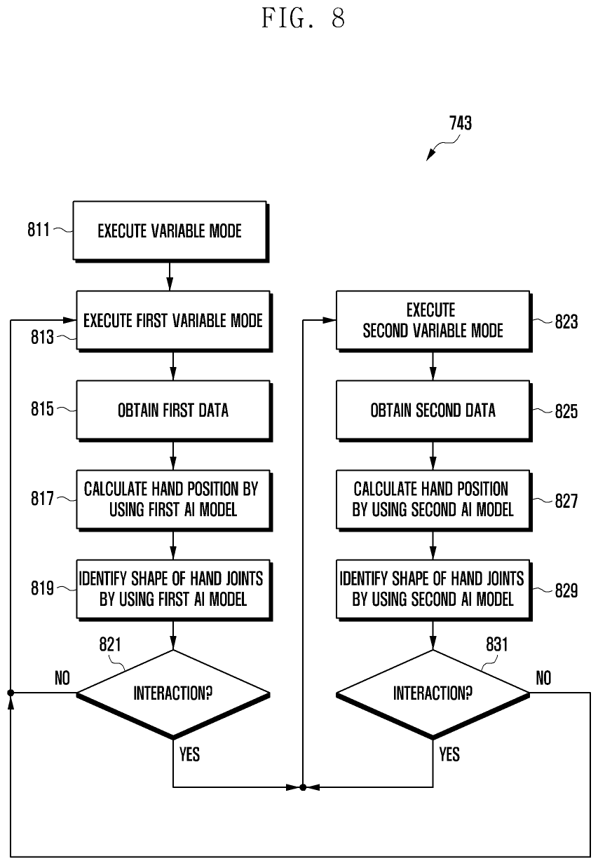

A specific method of determining whether the user interacts with at least one object included in an AR image in operation 743 will be described later in detail with reference to FIG. 8.

In operation 750, the electronic device 300 according to an embodiment may identify whether a first application termination trigger has occurred. The first application termination trigger may include receiving the user's direct input.

In operation 750, the electronic device 300 according to an embodiment may perform operation 760 in an example case in which the first application termination trigger occurs (e.g., the result of operation 750 is “Yes”).

In operation 750, the electronic device 300 according to an embodiment may perform operation 730 in an example case in which the first application termination trigger occurs (e.g., the result of operation 750 is “No”).

In operation 760, the electronic device 300 according to an embodiment may terminate the first application.

According to an embodiment, the electronic device 300 may perform operation 730 again in an example case in which a designated time has passed from a time point at which hand tracking according to operation 741, operation 742, or operation 743 is performed. For example, the electronic device 300 may perform hand tracking based on the first fixed mode, the second fixed mode, or the variable mode and count a time elapsing from a time point at which the hand tracking is performed. The electronic device 300 may, in an example case in which the counted time exceeds a designated time, perform operation 730 again to identify whether the electronic device 300 satisfies a designated condition.

FIG. 8 is a flowchart illustrating an operation according to a variable mode of the electronic device 300 according to an embodiment. For example, the flowchart illustrated in FIG. 8 may be a flowchart specifically illustrating operation 743 described with reference to FIG. 7.

At least some of the operations illustrated in FIG. 8 may be omitted. At least some operations mentioned with reference to other drawings in various embodiments of the disclosure may be added and inserted before or after at least some operations illustrated in FIG. 8.

Operations illustrated in FIG. 8 may be performed by the processor 120 (e.g., the processor 120 in FIG. 1). For example, the memory 130 (e.g., the memory 130 in FIG. 1) of the electronic device 300 (e.g., the electronic device 300 in FIG. 3) may store instructions that, when executed, cause the processor 120 to perform at least some operations illustrated in FIG. 8. Hereinafter, an operation according to a variable mode of the electronic device 300 according to an embodiment is described with reference to FIG. 8.

In operation 811, the electronic device 300 according to an embodiment may execute a variable mode. According to an embodiment, the hand position module 321 and the hand joint module 322 may be configured to, in the variable mode, use one of the first AI model or the second AI model according to whether the user interacts with at least one object included in an AR image. According to an embodiment, the hand position module 321 and the hand joint module 322 may execute the variable mode, based on receiving the user's direct input.

In operation 813, the electronic device 300 according to an embodiment may execute a first variable mode. For example, the hand position module 321 and the hand joint module 322 may be configured to, according to the first variable mode being activated, in an example case in which hand tracking is performed, perform a first deep learning calculation using a first AI model.

In operation 815, the electronic device 300 according to an embodiment may obtain first data for tracking the user's hand from the camera module 180 (e.g., the tracking camera unit 230 in FIG. 2) and/or a sensing module (e.g., the IMU sensor 310 in FIG. 3). For example, the first data may include image data input from the camera module 180 and/or sensing data input from the sensing module.

In operation 817, the electronic device 300 according to an embodiment may calculate the first data by using the first AI model to calculate the position of the user's hand. For example, the first AI model may calculate the position of the hand by processing image data of a first frame per second (FPS) included in the first data.

In operation 819, the electronic device 300 according to an embodiment may calculate the first data by using the first AI model, to identify (e.g., calculate) the shape of the user's hand joints (e.g., joint/mesh). For example, the first AI model may process image data of the first FPS included in the first data to identify the shape of the hand joints.

In operation 817 and operation 819, the electronic device 300 according to an embodiment may use the first AI model having a relatively small resource usage, but interpolate a box area representing the position of the user's hand calculated in the previous frame and estimate the hand position by using the interpolated box area so as to process image data of a relatively low FPS. The electronic device 300 according to an embodiment may use the first AI model having a relatively small resource usage, but interpolate the user's hand joints (e.g., joint/mesh) identified in the previous frame and estimate the interpolated hand joints so as to process image data of a relatively low FPS.

In operation 821, the electronic device 300 according to an embodiment may determine whether the user's hand is interactable with at least one object included in an AR image, or whether the user's hand interacts with the at least one object. For example, the interaction module 323 may, in calculating whether an interaction is possible or whether there is an interaction, comprehensively consider at least some of the position of the hand, the position of each hand joint, the current state of the object, or the current position of the object.

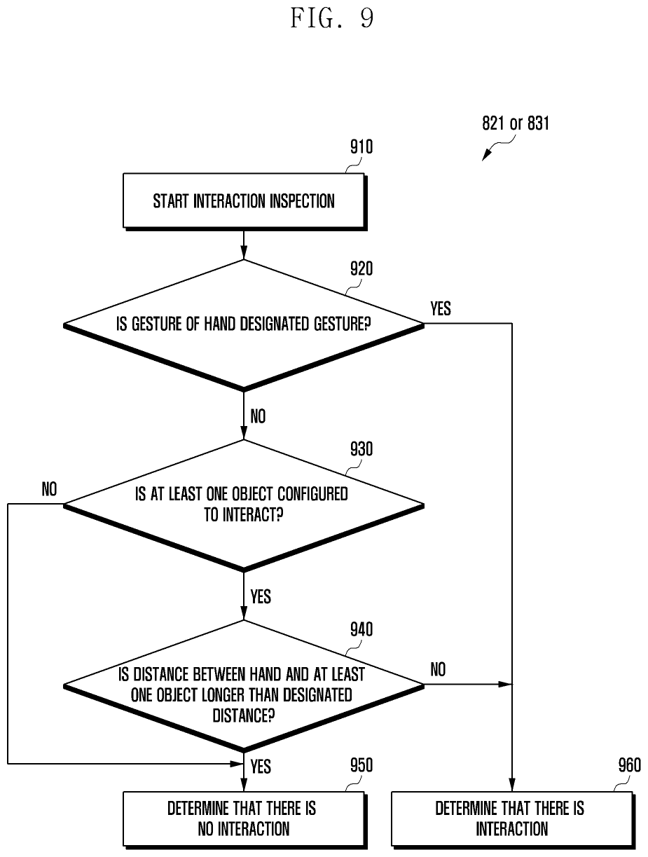

Determining, by the interaction module 323, whether an interaction is possible or whether there is an interaction in operation 821 will be described later in detail with reference to FIG. 9.

In operation 821, the electronic device 300 according to an embodiment may perform operation 823 based on a determination that there is an interaction (e.g., the result of operation 821 is “Yes”).

In operation 821, the electronic device 300 according to an embodiment may perform operation 813 based on a determination that there is no interaction (e.g., the result of operation 821 is “No”).

In operation 823, the electronic device 300 according to an embodiment may execute a second variable mode. For example, the hand position module 321 and the hand joint module 322 may be configured to, according to the second variable mode being activated, in an example case in which hand tracking is performed, perform a second deep learning calculation using a second AI model.

In operation 825, the electronic device 300 according to an embodiment may obtain second data for tracking the user's hand from the camera module 180 (e.g., the tracking camera unit 230 in FIG. 2) and/or a sensing module (e.g., the IMU sensor 310 in FIG. 3). For example, the second data may include image data input from the camera module 180 and/or sensing data input from the sensing module.

In operation 827, the electronic device 300 according to an embodiment may calculate the second data by using the second AI model to calculate the position of the user's hand. For example, the second AI model may calculate the position of the hand by processing image data of a second frame per second (FPS) included in the second data. The second FPS described in operation 827 may be greater than the first FPS described in operation 817.

In operation 829, the electronic device 300 according to an embodiment may calculate the second data by using the second AI model to identify the shape of the user's hand joints. For example, the second AI model may process image data of the second FPS included in the second data to identify the shape of the hand joints. The second FPS described in operation 829 may be greater than the first FPS described in operation 819.

In operation 827 and operation 829, the electronic device 300 according to an embodiment may use the second AI model having a relatively large resource usage and exhibiting high performance, but identify the position of the user's hand and the shape of the hand joints in every frame so as to process image data of a relatively high FPS.

In operation 831, the electronic device 300 according to an embodiment may determine whether the user's hand is interactable with at least one object included in an AR image, or whether the user's hand interacts with the at least one object. For example, the interaction module 323 may, in calculating whether an interaction is possible or whether there is an interaction, comprehensively consider at least some of the position of the hand, the position of each hand joint, the current state of the object, or the current position of the object. Determining, by the interaction module 323, whether an interaction is possible or whether there is an interaction in operation 831 will be described later in detail with reference to FIG. 9. For example, operation 831 may be substantially identical or similar to operation 821.

In operation 831, the electronic device 300 according to an embodiment may perform operation 823 based on a determination that there is an interaction (e.g., the result of operation 831 is “Yes”).

In operation 831, the electronic device 300 according to an embodiment may perform operation 813 based on a determination that there is no interaction (e.g., the result of operation 831 is “No”).

FIG. 9 is a flowchart illustrating an operation of determining whether there is an interaction by the electronic device 300 according to an embodiment. For example, the flowchart illustrated in FIG. 9 may be a flowchart specifically illustrating operation 821 or operation 831 described with reference to FIG. 8.

At least some of the operations illustrated in FIG. 9 may be omitted. At least some operations mentioned with reference to other drawings in various embodiments of the disclosure may be added and inserted before or after at least some operations illustrated in FIG. 9.

Operations illustrated in FIG. 9 may be performed by the processor 120 (e.g., the processor 120 in FIG. 1). For example, the memory 130 (e.g., the memory 130 in FIG. 1) of the electronic device 300 (e.g., the electronic device 300 in FIG. 3) may store instructions that, when executed, cause the processor 120 to perform at least some operations illustrated in FIG. 9. Hereinafter, an operation of determining whether there is an interaction by the electronic device 300 according to an embodiment is described with reference to FIG. 9.

In operation 910, the electronic device 300 according to an embodiment may start an inspection for determining whether there is an interaction in a variable mode. In various embodiments of the disclosure, an interaction being present may imply a state where the user's hand and at least one object included in an AR image provided by the electronic device 300 interact with each other. In various embodiments of the disclosure, an interaction being absent may imply a state where the user's hand and at least one object included in an AR image provided by the electronic device 300 do not interact with each other. In an example case in which there is no interaction, at least one object included in an AR image provided by the electronic device 300 may remain to be a designated image or have a designated shape regardless of the motion or gesture of the user's hand.

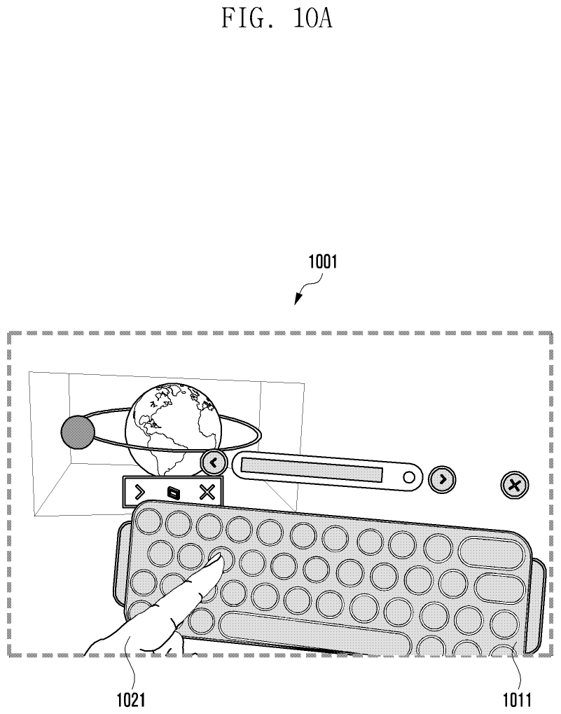

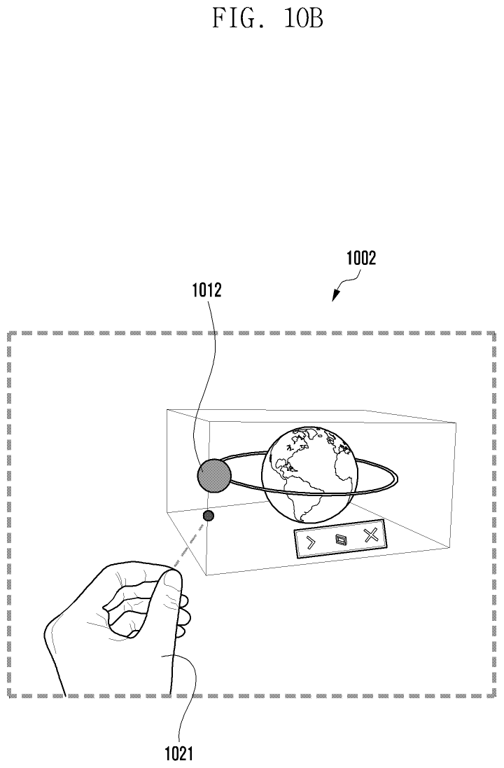

In operation 920, the electronic device 300 according to an embodiment may identify whether a detected gesture of the hand is a designated gesture. For example, the designated gesture may include a pointing gesture of a finger pointing to at least one object included in an AR image, as illustrated in FIG. 10A. For example, the designated gesture may include a pinch gesture of holding at least one object included in an AR image, as illustrated in FIG. 10B. The pointing gesture and the pinch gesture, as designated gestures described in various embodiments of the disclosure, merely correspond to an example and the designated gestures are not limited thereto and may further include various gestures recognizable by the electronic device 300 in an AR environment.

In operation 920, the electronic device 300 according to an embodiment may perform operation 960 in an example case in which the detected gesture of the hand is the designated gesture (e.g., the result of operation 920 is “Yes”).

In operation 920, the electronic device 300 according to an embodiment may perform operation 930 in an example case in which the detected gesture of the hand is not the designated gesture (e.g., the result of operation 920 is “No”).

In operation 930, the electronic device 300 according to an embodiment may identify whether at least one object included in an AR image is an object configured to be interactable. In various embodiments of the disclosure, an object being configured to be interactable may imply that the object is configured to interact with the position of the user's hand, the approach of the hand, or a particular gesture of the hand. In an example case in which a particular object is configured to be interactable, the electronic device 300 may perform a function related to the particular object in response to detecting the approach of the hand or a particular gesture of the hand relative to the particular object. The function related to the particular object may include a function of changing the shape or size of the particular object, a function of changing the position of the particular object, or a function of executing a function linked to the particular object.

In operation 930, the electronic device 300 according to an embodiment may perform operation 940 in an example case in which the at least one object included in the AR image is an object configured to be interactable (e.g., the result of operation 930 is “Yes”).

In operation 930, the electronic device 300 according to an embodiment may perform operation 950 in an example case in which the at least one object included in the AR image is not an object configured to be interactable (e.g., the result of operation 930 is “No”).

In operation 940, the electronic device 300 according to an embodiment may calculate the distance between the user's hand and the at least one object. For example, the electronic device 300 may determine whether the distance between the user's hand and the at least one object is longer than a designated distance.

In operation 940, the electronic device 300 according to an embodiment may perform operation 950 in an example case in which the distance between the user's hand and the at least one object is longer than the designated distance (e.g., the result of operation 940 is “Yes”).

In operation 940, the electronic device 300 according to an embodiment may perform operation 960 in an example case in which the distance between the user's hand and the at least one object is shorter than or equal to the designated distance (e.g., the result of operation 940 is “No”).

In operation 950, the electronic device 300 according to an embodiment may determine that there is no interaction. In an example case in which the at least one object included in the AR image is not an object configured to be interactable (e.g., the result of operation 930 is “No”), or in an example case in which the distance between the user's hand and the at least one object is longer than the designated distance (e.g., the result of operation 940 is “Yes”), the electronic device 300 may determine that there is no interaction. In an example case in which the at least one object included in the AR image is not an object configured to be affected by the position of a hand, the gesture of a hand, or the behavior of a hand, the electronic device 300 may determine that there is no interaction. In an example case in which the hand is positioned beyond a designated distance from an object configured to be affected by the position of a hand, the gesture of a hand, or the behavior of a hand, the electronic device 300 may determine that there is no interaction. In an example case in which the designated distance is configured to be about 10 cm, based on the hand being positioned beyond about 10 cm from the object, the electronic device 300 may determine that there is no interaction. For example, based on a determination that the hand is positioned beyond about 10 cm from the object, the electronic device 300 may determine that there is no interaction. The length of about 10 cm described as the designated distance merely corresponds to an example, and the disclosure may not be limited to the numerical value.

In operation 960, the electronic device 300 according to an embodiment may determine that there is an interaction. In an example case in which the detected gesture of the hand is the designated gesture (e.g., the result of operation 920 is “Yes”), or in an example case in which the distance between the user's hand and the at least one object is shorter than or equal to the designated distance (e.g., the result of operation 940 is “No”), the electronic device 300 may determine that there is an interaction. In an example case in which the gesture of the hand is a gesture (e.g., pointing gesture or pinch gesture) for long distance interaction, the electronic device 300 may determine that there is an interaction. In an example case in which the hand is positioned within a designated distance from an object configured to be affected by the position of a hand, the gesture of a hand, or the behavior of a hand, the electronic device 300 may determine that there is an interaction. In an example case in which the designated distance is configured to be about 10 cm, based on the hand being positioned within about 10 cm from the object, the electronic device 300 may determine that there is an interaction. For example, based on a determination that the hand being positioned within about 10 cm from the object, the electronic device 300 may determine that there is an interaction. The length of about 10 cm described as the designated distance merely corresponds to an example, and the disclosure may not be limited to the numerical value.

FIG. 10A illustrates a pointing gesture as an example of a designated gesture according to an embodiment.

Referring to FIG. 10A, a designated gesture 1021 according to an embodiment is a gesture for long distance interaction and may include a pointing gesture 1021. For example, as illustrated in FIG. 10A, the electronic device 300 (e.g., the electronic device 300 in FIG. 3) may display an AR image 1001 including a virtual keyboard 1011, and in an example case in which the pointing gesture 1021 of pointing to the virtual keyboard 1011 is detected, the electronic device 300 may determine that there is an interaction.

FIG. 10B illustrates a pinch gesture as an example of a designated gesture according to an embodiment.

Referring to FIG. 10B, the designated gesture 1021 according to an embodiment is a gesture for long distance interaction and may include the pinch gesture 1021. For example, as illustrated in FIG. 10B, the electronic device 300 (e.g., the electronic device 300 in FIG. 3) may display an AR image 1002 including an object 1012 configured to be interactable, and in an example case in which the pinch gesture 1021 for the object 1012 is detected, the electronic device 300 may determine that there is an interaction.

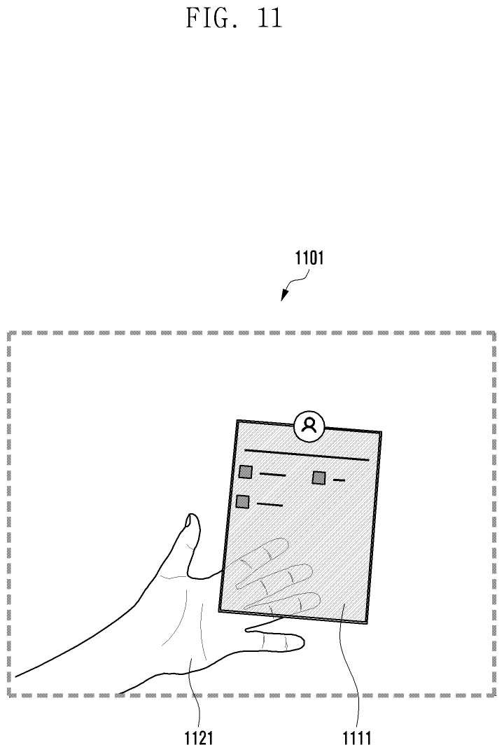

FIG. 11 illustrates an example of a user scenario of determining that there is no interaction by the electronic device 300 according to an embodiment.

Referring to FIG. 11, the electronic device 300 (e.g., the electronic device 300 in FIG. 3) according to an embodiment may display an AR image 1101 including an object 1111 to which a function related to interaction is not mapped and, while displaying the AR image 1101, determine that there is no interaction. For example, the at least one object 1111 included in the AR image 1101 provided by the electronic device 300 may be configured not to be affected by the position of a hand, the gesture of a hand, or the behavior of a hand. In this case, the object 1111 may remain to be a designated image or have a designated shape regardless of the motion or gesture of the user's hand 1121, and the electronic device 300 may determine that there is no interaction.

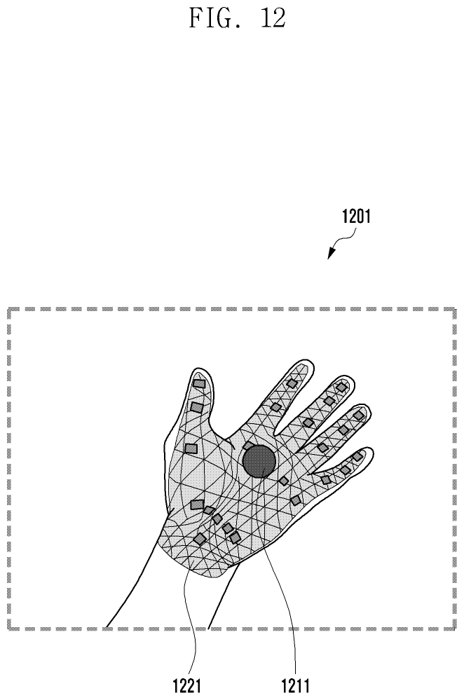

FIG. 12 illustrates an example of a user scenario of determining that there is an interaction by the electronic device 300 according to an embodiment.

Referring to FIG. 12, the electronic device 300 (e.g., the electronic device 300 in FIG. 3) according to an embodiment may be configured to generate an object, based on a hand position. For example, the electronic device 300 may map a function related to generation of an object 1211 to a particular position within an AR environment in which an AR image 1201 is displayed. In this case, the electronic device 300 may not display the object 1211 in an example case in which the user's hand 1221 is not at the particular position, and may display the object 1211 in an example case in which the user's hand 1221 is moved to the particular position. According to an embodiment, the electronic device 300 may determine that there is an interaction, in an example case in which the user's hand 1221 is positioned at the particular position to which the function related to generation of the object 1211 is mapped.

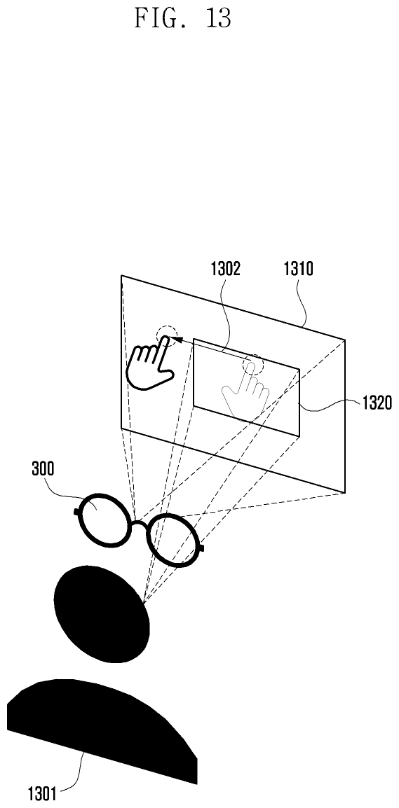

FIG. 13 is an example illustrating a state where the electronic device 300 according to an embodiment executes a second fixed mode, based on determining that there is an interaction.

Referring to FIG. 13, the electronic device 300 (e.g., the electronic device 300 in FIG. 3) according to an embodiment may, in a variable mode, based on whether there is an interaction, adaptively perform a high-efficient calculation of tracking a hand by using a first AI model or a high-performance calculation of tracking a hand by using a second AI model. In an example case in which there is an interaction, the electronic device 300 according to an embodiment may perform a high-performance calculation of tracking a hand by using the second AI model so as to increase the accuracy of the interaction. For example, in a case in which a gesture 1302 of moving an object included in an AR image out of a display area 1320 of the AR image is received from a user 1301, the electronic device 300 may perform high-performance hand tracking based on the second AI model, based on a result of determining that there is an interaction, so as to increase the accuracy of the interaction.

According to an embodiment, a reference numeral 1310 in FIG. 13 is a real scene (e.g., external image or external real picture) input from the camera module 180, and may be a camera input image 1310. The display area 1320 of the AR image may be positioned inside the camera input image 1310. The display area 1320 of the AR image may have an area smaller than that of the camera input image 1310.

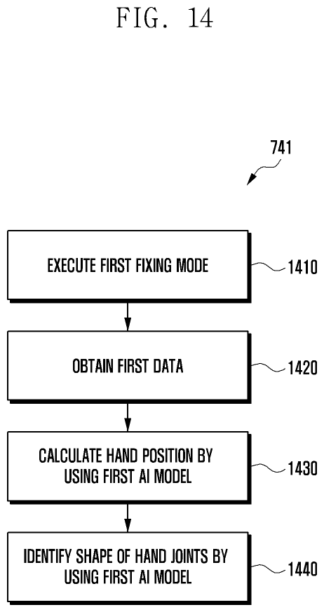

FIG. 14 is an example illustrating a state where the electronic device 300 according to an embodiment has executed a first fixed mode. For example, FIG. 14 may be a flowchart specifically illustrating operation 741 described with reference to FIG. 7.

However, the disclosure is not limited thereto, and as such, at least some of the operations illustrated in FIG. 14 may be omitted. At least some operations mentioned with reference to other drawings in various embodiments of the disclosure may be added and inserted before or after at least some operations illustrated in FIG. 14.

Operations illustrated in FIG. 14 may be performed by the processor 120 (e.g., the processor 120 in FIG. 1). For example, the memory 130 (e.g., the memory 130 in FIG. 1) of the electronic device 300 (e.g., the electronic device 300 in FIG. 3) may store instructions that, when executed, cause the processor 120 to perform at least some operations illustrated in FIG. 14. Hereinafter, a state where the electronic device 300 according to an embodiment has executed a first fixed mode is described with reference to FIG. 14.

In operation 1410, the electronic device 300 according to an embodiment may execute a first fixed mode. In an example case in which hand tracking is performed, the hand position module 321 and the hand joint module 322 may be configured to, according to the first fixed mode being activated, perform a first deep learning calculation using a first AI model. Operation 1410 may be identical or at least partially similar to operation 813 described with reference to FIG. 8.

In operation 1420, the electronic device 300 according to an embodiment may obtain first data for tracking the user's hand from the camera module 180 (e.g., the tracking camera unit 230 in FIG. 2) and/or a sensing module (e.g., the IMU sensor 310 in FIG. 3). For example, the first data may include image data input from the camera module 180 and/or sensing data input from the sensing module. Operation 1420 may be identical or at least partially similar to operation 815 described with reference to FIG. 8.

In operation 1430, the electronic device 300 according to an embodiment may calculate the first data by using the first AI model to calculate the position of the user's hand. For example, the first AI model may calculate the position of the hand by processing image data of a first frame per second (FPS) included in the first data. Operation 1430 may be identical or at least partially similar to operation 817 described with reference to FIG. 8.

In operation 1440, the electronic device 300 according to an embodiment may calculate the first data by using the first AI model to identify the shape of the user's hand joints.

For example, the first AI model may process image data of the first FPS included in the first data to identify the shape of the hand joints. Operation 1440 may be identical or at least partially similar to operation 819 described with reference to FIG. 8.

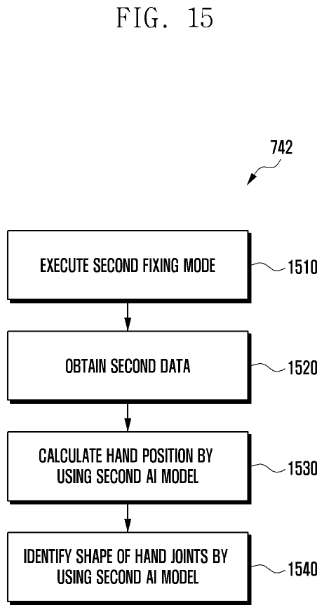

According to an embodiment, the electronic device 300 may perform an operation of identifying a state of the electronic device 300 in an example case in which a designated time has passed from a time point at which hand tracking according to operation 1410 to operation 1440 is performed. For example, the electronic device 300 may count a time elapsing from a time point at which the hand tracking based on the first fixed mode is performed. In an example case in which the counted time exceeds a designated time, the electronic device 300 may perform operation 730, described with reference to FIG. 7, again to identify whether the FIG. 15 is an example illustrating a state where the electronic device 300 according to an embodiment has executed a second fixed mode. For example, FIG. 15 may be a flowchart specifically illustrating operation 742 described with reference to FIG. 7.

However, the disclosure is not limited thereto, and as such, at least some of the operations illustrated in FIG. 15 may be omitted. At least some operations mentioned with reference to other drawings in various embodiments of the disclosure may be added and inserted before or after at least some operations illustrated in FIG. 15.

Operations illustrated in FIG. 15 may be performed by the processor 120 (e.g., the processor 120 in FIG. 1). For example, the memory 130 (e.g., the memory 130 in FIG. 1) of the electronic device 300 (e.g., the electronic device 300 in FIG. 3) may store instructions that, when executed, cause the processor 120 to perform at least some operations illustrated in FIG. 15. Hereinafter, a state where the electronic device 300 according to an embodiment has executed a second fixed mode is described with reference to FIG. 15.

In operation 1510, the electronic device 300 according to an embodiment may execute a second fixing mode. For example, the hand position module 321 and the hand joint module 322 may be configured to, according to the second fixing mode being activated, in an example case in which hand tracking is performed, perform a second deep learning calculation using a second AI model. Operation 1510 may be identical or at least partially similar to operation 823 described with reference to FIG. 8.

In operation 1520, the electronic device 300 according to an embodiment may obtain second data for tracking the user's hand from the camera module 180 (e.g., the tracking camera unit 230 in FIG. 2) and/or a sensing module (e.g., the IMU sensor 310 in FIG. 3). For example, the second data may include image data input from the camera module 180 and/or sensing data input from the sensing module. Operation 1520 may be identical or at least partially similar to operation 825 described with reference to FIG. 8.

In operation 1530, the electronic device 300 according to an embodiment may calculate the second data by using the second AI model to calculate the position of the user's hand. For example, the second AI model may calculate the position of the hand by processing image data of a second frame per second (FPS) included in the second data. The second FPS described in operation 1530 may be greater than the first FPS described in operation 1430 of FIG. 14. Operation 1530 may be identical or at least partially similar to operation 827 described with reference to FIG. 8.

In operation 1540, the electronic device 300 according to an embodiment may calculate the second data by using the second AI model to identify the shape of the user's hand joints. For example, the second AI model may process image data of the second FPS included in the second data to identify the shape of the hand joints. The second FPS described in operation 1540 may be greater than the first FPS described in operation 1440 of FIG. 14. Operation 1540 may be identical or at least partially similar to operation 829 described with reference to FIG. 8.

According to an embodiment, the electronic device 300 may perform an operation of identifying a state of the electronic device 300 in an example case in which a designated time has passed from a time point at which hand tracking according to operation 1510 to operation 1540 is performed. For example, the electronic device 300 may count a time elapsing from a time point at which the hand tracking based on the second fixing mode is performed. In an example case in which the counted time exceeds a designated time, the electronic device 300 may perform operation 730, described with reference to FIG. 7, again to identify whether the

An electronic device (e.g., the electronic device 101 in FIG. 1) according to an embodiment may include at least one sensor module (e.g., the sensor module 176 in FIG. 1) configured to detect a user's hand, and a processor (e.g., the processor 120 in FIG. 1) operatively connected to the at least one sensor module 176, wherein the processor 120 is configured to execute a first application for providing an augmented reality (AR) image to the user, select a first artificial intelligence (AI) model, based on execution of the first application, obtain first data related to the user's hand from the at least one sensor module 176, identify a position of the user's hand and a shape of the hand's joints by calculating the first data by using the first AI model, based on the position of the user's hand and the hand's joints identified using the first AI model, determine whether there is an interaction between the user's hand and at least one object included in the AR image, select a second AI model, based on determination that there is an interaction between the user's hand and at least one object included in the AR image, obtain second data related to the user's hand from the at least one sensor module 176, and identify a position of the user's hand and a shape of the hand's joints by calculating the second data by using the second AI model, and wherein the first AI model is an AI model configured to process a first calculation amount for a particular time period, and the second AI model is an AI model configured to process a second calculation amount greater than the first calculation amount for the particular time period.

According to an embodiment, the first AI model may be an AI model configured to process image data of a first frame per second (FPS) for the particular time period, and the second AI model may be an AI model configured to process image data of a second frame per second (FPS) for the particular time period.

According to an embodiment, a resource usage of the processor 120 consumed by the second AI model may be greater than that of the processor 120 consumed by the first AI model.

According to an embodiment, the processor 120 may be configured to, based on the position of the user's hand and the hand's joints identified using the first AI model, determine a gesture of the user's hand, identify whether the determined gesture is a designated gesture, and in case that the determined gesture is the designated gesture, determine that the interaction is present.

According to an embodiment, the designated gesture may include a pointing gesture for the at least one object.

According to an embodiment, the designated gesture may include a pinch gesture for the at least one object.

According to an embodiment, the processor may be configured to identify whether the object is an object configured to interact, in case that the at least one object is an object not configured to interact, determine that the interaction is absent, in case that the at least one object is an object configured to interact, identify whether a distance between the position of the user's hand and the at least one object is longer than a designated distance, and in case that the distance between the position of the user's hand and the at least one object is longer than the designated distance, determine that the interaction is absent.

According to an embodiment, the processor 120 may be configured to, in case that the distance between the position of the user's hand and the at least one object is equal to or shorter than the designated distance, determine that the interaction is present.

According to an embodiment, the processor 120 may be configured to, while identifying a position of the user's hand and a shape of the hand's joints by calculating the first data by using the first AI model or the second AI model, identify whether the electronic device 101 satisfies a designated first condition, and in case that the first condition is satisfied, activate a first fixing mode of tracking the user's hand by fixedly using the first AI model.

According to an embodiment, the first condition may include receiving a user input related to the first condition, or detecting a state where remaining battery power is lower than a threshold value.

According to an embodiment, the processor 120 may be configured to, while identifying a position of the user's hand and a shape of the hand's joints by calculating the first data by using the first AI model or the second AI model, identify whether the electronic device 101 satisfies a designated second condition, and in case that the second condition is satisfied, activate a second fixing mode of tracking the user's hand by fixedly using the second AI model.

According to an embodiment, the first condition may include receiving a user input related to the second condition, or detecting a state where the user's gesture repeatedly fails to be recognized a designated number of times or more.

A method of an electronic device 101 according to an embodiment may include executing a first application for providing an augmented reality (AR) image to a user, selecting a first artificial intelligence (AI) model, based on execution of the first application, obtaining first data related to the user's hand from at least one sensor module 176, identifying a position of the user's hand and a shape of the hand's joints by calculating the first data by using the first AI model, based on the position of the user's hand and the hand's joints identified using the first AI model, determining whether there is an interaction between the user's hand and at least one object included in the AR image, selecting a second AI model, based on determination that there is an interaction between the user's hand and at least one object included in the AR image, obtaining second data related to the user's hand from the at least one sensor module 176, and identifying a position of the user's hand and a shape of the hand's joints by calculating the second data by using the second AI model, wherein the first AI model is an AI model configured to process a first calculation amount for a particular time period, and the second AI model is an AI model configured to process a second calculation amount greater than the first calculation amount for the particular time period.

According to an embodiment, the first AI model may be an AI model configured to process image data of a first frame per second (FPS) for the particular time period, and the second AI model may be an AI model configured to process image data of a second frame per second (FPS) for the particular time period.

According to an embodiment, a resource usage of the processor 120 consumed by the second AI model may be greater than that of the processor 120 consumed by the first AI model.

The method of the electronic device 101 according to an embodiment may include, based on the position of the user's hand and the hand's joints identified using the first AI model, determining a gesture of the user's hand, identifying whether the determined gesture is a designated gesture, and in case that the determined gesture is the designated gesture, determining that the interaction is present.

According to an embodiment, the designated gesture may include a pointing gesture for the at least one object.

According to an embodiment, the designated gesture may include a pinch gesture for the at least one object.

The method of the electronic device 101 according to an embodiment may include identifying whether the at least one object is an object configured to interact, in case that the at least one object is an object not configured to interact, determining that the interaction is absent, in case that the at least one object is an object configured to interact, identifying whether a distance between the position of the user's hand and the at least one object is longer than a designated distance, and in case that the distance between the position of the user's hand and the at least one object is longer than the designated distance, determining that the interaction is absent.

The method of the electronic device 101 according to an embodiment may include, in case that the distance between the position of the user's hand and the at least one object is equal to or shorter than the designated distance, determining that the interaction is present.

In an electronic device and a method according to an embodiment of the disclosure, when an operation of detecting a user's hand is performed, a calculation amount may be adaptively adjusted to reduce unnecessary use of resources so as to increase system efficiency.

In an electronic device and a method according to an embodiment of the disclosure, when an operation of detecting a user's hand is performed, a calculation amount may be adaptively adjusted to reduce power consumption.

The disclosure has been illustrated and described with reference to its various embodiments. However, it will be understood by those skilled in the art that various changes in form and details may be made without departing from the spirit and scope of the disclosure described below. The disclosure is defined by the appended claims and their equivalents.

What is claimed is:

1. An electronic device comprising:
memory storing instructions;
at least one sensor module configured to detect a hand of a user; and
at least one processor comprising processing circuitry;
wherein the instructions, when executed by the at least one processor individually or collectively, cause the electronic device to:
execute a first application configured to provide an augmented reality (AR) image to the user;
select a first artificial intelligence (AI) model, based on execution of the first application;
obtain first data related to the hand of the user from the at least one sensor module;
identify a position of the hand of the user and a shape of joints in the hand by using the first AI model to calculate the first data;
based on the position of the hand of the user and the joints in the hand, identified using the first AI model, determine whether there is an interaction between the hand of the user and at least one object included in the AR image;
select a second AI model, based on determination that there is an interaction between the hand of the user and at least one object included in the AR image;
obtain second data related to the hand of the user from the at least one sensor module; and
identify a position of the hand of the user and a shape of the joints in the hand by using the second AI model to calculate the second data, and
wherein the first AI model is configured to process a first calculation amount for a first time period, and the second AI model is configured to process a second calculation amount greater than the first calculation amount for the first time period.

2. The electronic device of claim 1, wherein the first AI model is configured to process image data of a first frame per second (FPS) for the first time period,
wherein the second AI model is configured to process image data of a second frame per second (FPS) for the first time period, and
wherein, in the first time period, a resource usage of the processor consumed by the second AI model is greater than a resource usage of the processor consumed by the first AI model.

3. The electronic device of claim 1, wherein the instructions, when executed by the at least one processor individually or collectively, cause the electronic device to:
based on the position of the hand of the user and the joints in the hand, identified using the first AI model, determine a gesture of the hand of the user;
identify whether the determined gesture is a first gesture; and
based on the determined gesture being the first gesture, determine that the interaction is present.

4. The electronic device of claim 3, wherein the first gesture comprises a pointing gesture for the at least one object.

5. The electronic device of claim 3, wherein the first gesture comprises a pinch gesture for the at least one object.

6. The electronic device of claim 1, wherein the instructions, when executed by the at least one processor individually or collectively, cause the electronic device to:
identify whether the at least one object is an object configured to interact;
based on the at least one object not being configured to interact, determine that the interaction is absent;
based on the at least one object being configured to interact, identify whether a distance between the position of the hand of the user and the at least one object is longer than a first distance; and
based on the distance between the position of the hand of the user and the at least one object being longer than the first distance, determine that the interaction is absent.

7. The electronic device of claim 6, wherein the instructions, when executed by the at least one processor individually or collectively, cause the electronic device to, based on the distance between the position of the hand of the user and the at least one object being equal to or shorter than the first distance, determine that the interaction is present.

8. The electronic device of claim 1, wherein the instructions, when executed by the at least one processor individually or collectively, cause the electronic device to:
while identifying a position of the hand of the user and a shape of the joints in the hand by using the first AI model or the second AI model to calculate the first data, identify whether the electronic device satisfies a condition; and
based on the condition being satisfied, activate a first fixed mode of tracking the hand of the user by fixedly using the first AI model.

9. The electronic device of claim 8, wherein the condition comprises:
receiving a user input related to the condition; or
detecting a state where remaining battery power is lower than a threshold value.

10. The electronic device of claim 8, wherein the instructions, when executed by the at least one processor individually or collectively, cause the electronic device to:
while identifying a position of the hand of the user and a shape of the joints of the hand by using the first AI model or the second AI model to calculate the first data, identify whether the electronic device satisfies a condition; and
based on the condition being satisfied, activate a second fixed mode of tracking the hand of the user by fixedly using the second AI model.

11. The electronic device of claim 10, wherein the condition comprises:
receiving a user input related to the condition; or
detecting a state where the gesture of the user is unsuccessfully recognized repeatedly a number of times or more.

12. A method of an electronic device, the method comprising:
executing a first application configured to provide an augmented reality (AR) image to a user;
selecting a first artificial intelligence (AI) model, based on execution of the first application;
obtaining first data related to a hand of the user from at least one sensor module;
identifying a position of the hand of the user and a shape of joints in the hand by using the first AI model to calculate the first data;
based on the position of the hand of the user and the joints in the hand identified using the first AI model, determining whether there is an interaction between the hand of the user and at least one object included in the AR image;
selecting a second AI model, based on determination that there is an interaction between the hand of the user and at least one object included in the AR image;
obtaining second data related to the hand of the user from the at least one sensor module; and
identifying a position of the hand of the user and a shape of the joints in the hand by using the second AI model to calculate the second data,
wherein the first AI model is configured to process a first calculation amount for a first time period, and the second AI model configured to process a second calculation amount greater than the first calculation amount for the first time period.

13. The method of claim 12, wherein the first AI model is configured to process image data of a first frame per second (FPS) for the first time period,
wherein the second AI model is configured to process image data of a second frame per second (FPS) for the first time period, and
wherein, for the first time period, a resource usage of the processor consumed by the second AI model is greater than that of the processor consumed by the first AI model.

14. The method of claim 12, further comprising:
based on the position of the hand of the user and the joints in the hand, identified using the first AI model, determining a gesture of the hand of the user;
identifying whether the determined gesture is a first gesture; and
based on the determined gesture being the first gesture, determining that the interaction is present.

15. The method of claim 14, wherein the first gesture comprises a pointing gesture for the at least one object.
